(19) United States
(12) Patent Application Publication
(10) Pub. No.: US 2004/0101970 A1
(43) Pub. Date: May 27, 2004

(54) Treatment solution minimising adsorption and/or elecroosmosis phenomena

(76) Inventors: Jean-Louis Viovy, Paris (FR); Valessa Barbier, Paris (FR)

Correspondence Address: YOUNG & THOMPSON, 745 SOUTH 23RD STREET 2ND FLOOR, ARLINGTON, VA, 22202

(21) Appl. No.: 10/312,537

(22) PCT Filed: Jul. 2, 2001
(86) PCT No.: PCT/FR01/02117

(30) Foreign Application Priority Data
Jun. 30, 2000 (FR) 00/08528

(51) Int. Cl. G01N 1/00

(52) U.S. Cl. 436/174

(57) ABSTRACT

A surface treatment solution for an element designed to be contacted with a fluid and/or species contained in the fluid when the fluid is being transported, analyzed, purified, separated or preserved. The method is characterised in that the solution comprises at least a polymer consisting of several polymeric segments, the polymer being of the block copolymer type or comb-like polymer type having at least three junction points between the polymeric segments of different chemical or topological nature. The invention also concerns methods using the solution for treating an element to be contacted with a fluid and/or species contained in the fluid during preservation, transport, analysis, purification or separation of the fluid.

The present invention relates to the transfer, analysis, purification or separation, within a channel, of a fluid or a species contained in said fluid, or to the conservation of a fluid in a container, and is more particularly directed toward proposing a surface treatment solution which is of use in significantly reducing the nonspecific adsorption of species contained in this fluid to the walls of said channel or of said container.

The invention is more particularly advantageous for methods in which said fluid is contained in channels or capillaries, at least one of the dimensions of which is submillimeter, and typically between 1 μm and 200 μm (hereafter referred to as microchannels).

More particularly, the invention relates to techniques for analyzing or for separating species, according to which it is necessary to transport said species in a channel, while at the same time minimizing the nonspecific interactions of said species, or of other components of said medium, with the walls of said channel or more generally with walls or solid elements present in said channel or said medium. These are in particular methods for separating or for analyzing biological macromolecules by capillary electrophoresis, by chromatography or by any method carried out in microchannels (microfluid systems, “laboratories on chips”). Examples of such systems are described, for example, in “Capillary electrophoresis in analytical. biotechnology”, Righetti ed., CRC press, 1996, or in J. Cheng et al. (1996), Molecular Diagnosis, 1, 183-200. The invention is of particular use in the case of electrophoresis.

The invention also relates to “hybridization” or “affinity” techniques in which the aim is to analyze, within a channel or a container, the species contained in a sample, as a function of their specific affinity for ligands contained in said channel or container, or attached to the walls of said container or said channel, at predetermined positions.

In the context of the invention, the term “nonspecific adsorption” is intended to be used as normally accepted by those skilled in the art, as an interaction of attraction between certain species or impurities contained in a sample and the walls of the container and of the channel which depends weakly or in an insufficiently controlled manner on the characteristics of said species or impurities. In the remainder of the text, the term “adsorption” or “nonspecific adsorption” will be used indifferently to denote the latter, as opposed to an interaction of specific affinity. The term “affinity” is intended to mean an interaction between a species and a substrate, the strength of which depends strongly on said species and on said substrate, and which, in any event, is sufficient to induce the separation or the identification of various species as a function of their biological or physicochemical characteristics.

In the remainder of the text, the term “microfluid system” will denote any system in which fluids and/or species contained in a fluid are moved within a channel, or within a set of channels, at least one of the dimensions of which is submillimeter, and the term “capillary electrophoresis” (CE) will denote microfluid systems in which the species are transported under the action of an electric field. The CE and the microfluid systems enable separations which are more rapid and which give better resolution than the older methods of gel electrophoresis, they do not call for anticonvective medium, and their properties have been widely used to carry out ion separations in liquid medium.

At the current time, the vast majority of biological macromolecule separations carried out by CE make use, as separating medium, of solutions of water-soluble, linear, noncrosslinked polymers which have the advantage that they can be replaced as often as necessary. Many noncrosslinked polymers have been proposed as media for separating species within a channel, in particular in the context of capillary electrophoresis.

A major problem for all methods involving species within channels is the nonspecific adsorption of said species to the walls of said channels. This problem is particularly exacerbated in the case of channels of small dimensions and of biological macromolecules, the latter often being amphiphilic.

In the case of analytical methods, the consequence of this phenomenon of nonspecific adsorption to the walls by species contained in the sample or the fluid is to delay certain analytes and to create an additional dispersion and therefore a loss of resolution. This adsorption may also give rise to a contamination of the channel walls, liable to affect the fluids intended to be subsequently introduced into this channel. Finally, if the analysis desired to be carried out on the species involves a specific interaction of the species with the separation medium, as in chromatography, electrochromatography or affinity electrophoresis methods, or with predetermined areas of the walls, as in hybridization methods such as “DNA chips” or “protein chips”, or else with solid walls contained in the channel or container, as in methods of separation by affinity with latex, these adsorption phenomena may compete with the desired specific interactions and interfere with or prevent the analysis.

Another limitation, which concerns more particularly electrokinetic separation methods, is electroosmosis, an overall movement of the separation medium due to the presence of charges on the walls of the capillary or of the channel. Since this movement is often variable over time and is not uniform, it is harmful to the reproducibility of the measurements and to the resolution. It is due to the charges which may be present at the surface of the capillary on account of its chemical structure, but may also be generated or increased by the adsorption onto the wall of charged species initially contained in the samples to be separated, and in particular proteins.

The present invention is more particularly concerned with the inhibition of these two phenomena, namely adsorption of species to the surfaces and/or electroosmosis.

Methods have already been proposed for combating electroosmosis and/or adsorption of species to surfaces. A first type of method involves treating the surface of the channel by adsorption of essentially neutral species, prior to the actual separation (Wiktorowicz et al., Electrophoresis, 11, 769, 1990, Tsuji et al., J. Chromatogr. 594, 317 (1992)). It has also been proposed to adsorb surface agents with a charge which is opposite to that of the wall, to reinforce the adhesion by electrostatic interactions.

In fact, these methods reduce electroosmosis to a certain degree, but they are relatively ineffective in preventing the adsorption of complex species of high molecular mass, such as, for example, proteins.

A more effective solution consists in irreversibly grafting an essentially neutral polymeric layer, such as acrylamide or polyvinyl alcohol, onto the walls, as described, for example, in U.S. Pat. No. 4,680,201, or alternatively U.S. Pat. No. 5,502,169 or U.S. Pat. No. 5,112,460. Ready-to-use treated capillaries are thus commercially available. These irreversibly treated capillaries give good reduction of electroosmosis for a certain number of separations. Unfortunately, they have a limited life span and are expensive.

It has also been proposed to use, in the separation medium, polymers with properties of adsorption to walls, such as methylcellulose (Hjerten, Chromatographic reviews, 9, 122, 1967) or polyvinyl-pyrrolidone (Mazzeo et al., Anal. Chem., 63, 2852, 1991). In application WO 98/10274, copolymers having affinity with walls of silica and capable of significantly reducing electroosmosis are proposed. The polymers described are triblock polymers of low molecular masses (typically less than 20 000), of the polyoxyethylene-polyoxypropylene-polyoxypropylene (POE-POP-POE) family. However, these polymers have a limited range of application. They require a change in temperature between the introduction into the capillary and the analytical phase, they only exert their beneficial effect at high concentrations, and they are also relatively hydrophobic, which makes them unsuitable for example for DNA sequencing. In addition, in these various methods of the prior art using polymers in the separation medium, the presence of the polymer is accompanied by a considerable variation in the physical properties, and in particular by a considerable increase in viscosity, which may pose problems for the introduction of fluid into the channel and for the separation properties themselves.

In U.S. Pat. No. 5,552,028, it is also proposed to use separation media comprising a sieving medium and a surface interaction component consisting of a polymer with properties of adsorption to walls, having a molecular mass of between 5 000 and 1 000 000, of the disubstituted acrylamide polymer type. These matrices, and more particularly polydimethylacrylamide (PDMA), make it possible to reduce electroosmosis and, for some applications, such as sequencing, produce good separation properties. However, they are relatively hydrophobic, which limits their effectiveness for some applications such as DNA sequencing, and is even more harmful for other applications such as protein separation. Moreover, they produce slow separations.

Consequently, although many methods have been proposed for reducing adsorption to walls and/or electroosmosis, they are not found to be totally satisfactory.

The object of the present invention is precisely to provide a novel family of surface treatment solutions which are advantageous for minimizing the phenomena of nonspecific adsorption and of electroosmosis.

More particularly, a subject of the present invention is a solution for treating the surface of an element intended to be brought into contact with a fluid and/or species contained in this fluid during the transport, analysis, purification, separation or conservation of said fluid, characterized in that said solution comprises at least one polymer composed of several polymer segments, said polymer being of the block copolymer or comb polymer type and having on average at least three junction points between polymer segments which are chemically or topologically different in nature.

The term “crosslinked” is intended to mean, as normally accepted by those skilled in the art, a set of polymers exhibiting between them a large-scale network of crosslinking points, which confers on this, set of polymers the properties of a solid or of a gel.

In the present invention, the term “element” is more particularly intended to denote mainly any channel used for the transport, analysis, purification and separation of a fluid or of species contained in this fluid, or any container used to conserve a fluid. Also covered under this definition are solid particles such as beads, for example, liable to be brought into contact with a fluid for the purposes of analysis, separation or purification, in particular by affinity. This definition also extends to any element intended to constitute a wall of a channel or of a container used in an operation of transport, analysis, purification, conservation or separation of a fluid or of species contained in this fluid, or to be part of said wall. The treatment, using such a solution, of the surface of “DNA chips”, as described, for example, in “Nature Genetics”, 1999, 21, 1-60, of “protein chips”, of microtitration plates, or more generally of surfaces intended to be brought into contact with a fluid in a system of analysis or separation, or in a “high throughput screening” system, in particular falls within the scope of the invention.

According to a preferred variant, the polymer according to the invention has a chemical composition which is different from that of the materials making up said element. It may thus confer on the walls of said channel or of said container advantageous properties which are difficult or impossible to obtain in its absence, given the chemical nature of the elements making up the channel or the container.

Advantageously therefore, the polymers used according to the invention minimize the adsorption of species to the walls and thus improve either the rate of recovery of these species, for example in preparative or micropreparative systems, or the resolution in analytical methods, or else avoid the contamination of said walls, in particular in the transport, analysis or conservation of biological fluids liable to contaminate.

For the purpose of the invention, the term “polymer” is intended to denote a product consisting of a set of macromolecules and characterized by certain properties such as molecular mass, polydispersity, chemical composition and/or microstructure. The term “polydispersity” is intended to denote the molecular mass distribution of the macromolecules, in the sense of the weight average familiar to those skilled in the art. The term “microstructure” is intended to mean the way in which the monomers which make up the chemical composition of the macromolecules are arranged within these macromolecules.

The invention is particularly advantageous in the case of methods of separation of species within a fluid. For the purpose of the invention, the expression “separation” is intended to cover any method aimed at separating, identifying or analyzing all or some of the species contained in a sample. In this case, the fluid is called “separation medium”. The term “species” is generally intended to denote particles, organelles or cells, molecules or macromolecules, and in particular biological molecules such as nucleic acids (DNA, RNA, oligonucleotides), nucleic acid analogs obtained by chemical modification or synthesis, proteins, polypeptides, glycopeptides and polysaccharides. In analytical methods, said species are commonly called “analytes”.

The invention is particularly advantageous in the case of electrokinetic separation methods.

The expression “electrokinetic separation” is intended to cover any method aimed at separating all or some of the species contained in a mixture, by causing them to migrate within a medium under the action of an electric field, regardless of whether the field exerts its driving action on the analytes directly or indirectly, for example via displacement of the medium itself, such as in electrochromatography, or via displacement of subsidiary species such as micelles, in the case of micellar electrochromatography, or by any combination of direct and indirect action. Any method of separation in which said action of the electric field is combined with another driving action of non-electric origin will also be considered to be an electrokinetic separation method according to the invention. Consequently, methods of capillary electrophoresis or electrophoresis on “chips” are also referred to as “electrokinetic” methods.

Advantageously, in particular in the case of electrokinetic separations, the fluid consists of an electrolyte.

For the purpose of the invention, the term “electrolyte” is intended to denote a condensed medium capable of conducting ions. In the most common case, this medium is a buffered aqueous medium, such as the buffers based on phosphate, on tris(hydroxymethyl)-aminomethane (TRIS), on borate, on N-tris(hydroxymethyl)methyl-3-aminopropanesulfonic acid (TAPS), on histidine, on lysine, etc. Many examples of buffers which can be used in electrophoresis are known to those skilled in the art, and a certain number of them are described, for example, in Sambrook et al., “Molecular Cloning: A laboratory manual”, Cold Spring Harbor Lab, New York, 1989. However, all types of electrolyte may be used in the context of the invention, in particular aqueous-organic solvents such as, by way of example, water-acetonitrile, water-formamide or water-urea mixtures, and polar organic solvents such as, again by way of example, N-methylformamide. “Sequencing buffer” electrolytes consisting of an aqueous buffer at alkaline pH supplemented with a notable proportion of urea and/or formamide are found to be of particular use in the context of the invention.

The term “channel” is intended to denote any volume delimited by one or more solid walls, having at least two orifices, intended to contain a fluid or to have a fluid pass through it. The term “container” is intended to denote any volume delimited by several solid walls, having at least one orifice and used to contain a fluid.

The invention is particularly advantageous in systems comprising at least one channel or one container, at least one dimension of which is sub-millimeter in size, such as capillary electrokinetic separation systems, microfluid systems and, more generally, systems for separating species using micro-channels, microcontainers or nanocontainers.

According to a preferred variant, the polymers according to the invention exhibit on average at least four junction points, preferably a number of junction points of between 4 and 100, and more preferentially a number of junction points of between 4 and 40.

The term “junction point” is intended to mean a point connecting either two polymer segments which are significantly chemically different in nature, such as in the case of a block copolymer, or a point of crosslinking between a number of polymer segments, chemically identical or different in nature, greater than two, as in comb polymers.

By way of example, a comb polymer comprising three side branches comprises three junction points and seven distinct polymer segments. Still by way of example, a linear block copolymer of the A-B-A-B type comprises three junction points and four distinct polymer segments.

In accordance with the invention, the term “polymer segment” or “segment” is intended to denote a set of monomers linked to one another covalently and in a linear fashion, and belonging to a given type of chemical composition, i.e. having specific physicochemical properties overall, in particular as regards sorvation and/or interaction with a solid wall. An example of a polymer segment for the purpose of the invention is given by a chain of monomers which are all identical (homopolymer segment), or a copolymer which exhibits no significant correlation of composition over distances of more than a few monomers (segment of the random copolymer type).

For the purpose of the invention, the term “block copolymer” is intended to denote a copolymer consisting of polymer segments connected to one another covalently, and belonging to at least two different types of chemical composition. Thus, two polymer segments which are adjacent within a block copolymer are, by definition within the context of the invention, significantly chemically different in nature. The block copolymer is defined by the fact that each of the segments comprises a sufficient number of monomers to exhibit, within the electrolyte, physicochemical and, in particular, solvation properties which are comparable to those of a homopolymer of the same composition and of the same size. It is the opposite of the random copolymer, in which the various types of monomer follow on from one another in an essentially random manner, and confer locally on the chain overall properties which are different from those of the homopolymers of each of the species in question. The size of the homopolymer segments required to obtain this block characteristic may vary depending on the types of monomer and on the electrolyte, but it is typically a few tens of atoms along the backbone of said segment. It should be noted that it is possible to constitute a block copolymer within the meaning of, the invention, in which some or all of the segments themselves consist of a copolymer of the random type, insofar as it is possible to distinguish within said block copolymer polymer segments of sufficient size and of sufficient difference in chemical composition to give, from one segment to the other, a significant variation in the physicochemical properties, and in particular in salvation and/or in interaction with the walls. In particular, in order to be considered as a “polymer segment” for the purpose of the invention, a portion of polymer must comprise at least 10 atoms along its backbone.

According to a preferred variant, the polymer according to the invention is of the linear block copolymer type.

For the purpose of the invention, the expression “linear block copolymer” is intended to mean a block copolymer composed of polymer segments belonging to at least two distinct chemical types, said polymer segments being linked to one another in a linear manner.

According to another preferred variant, the polymer according to the invention is of the comb polymer type.

For the purpose of the invention, the term “comb polymer” is intended to denote a polymer having a linear backbone of a certain chemical nature, and polymer segments called “side branches”, chemically identical or different in nature, which are also linear, but significantly shorter than the backbone, attached covalently to said backbone by one of their ends. In a comb polymer, the polymer segments constituting the backbone and those constituting the side branches differ in terms of their topological nature. If the polymer segments constituting the side branches of the comb polymer and those constituting its backbone also differ in terms of their chemical nature, the polymer has both the characteristic of a “comb polymer” and that of a “block copolymer”. Such polymers, which are called “comb copolymers”, constitute a subset of comb polymers and may, of course, be used in the context of the invention.

The number of polymer segments of a given chemical or topological type present in the polymers according to the invention is understood to be an average value, it being understood that it always involves a population of a large number of molecules, exhibiting in said numbers a certain polydispersity. In the present description, and unless otherwise stated, all the molecular masses, and also all the averages regarding sets of chains or regarding sets of polymer segments, such as the average molecular mass, the average number of atoms along the backbone, the number of junction points or the average number of grafts in the case of a comb polymer, are understood to be weight averages within the usual meaning of polymer physics.

According to a preferred variant, the polymer according to the invention is of the irregular type, i.e. all the segments of at least one type of chemical or topological nature which make it up exhibit a polydispersity of at least 1.5, and preferably greater than 1.8.

The polydispersity of a type of polymer segment which makes up a polymer according to the invention is understood to be the average value of the molecular mass of said segments, taken over all the segments of this type (weight average in the usual sense of polymer physicochemistry).

A preferred variant of irregular comb polymer consists in exhibiting a side branch polydispersity of at least 1.5, and preferably greater than 1.8.

Another preferred variant of irregular comb polymer consists in exhibiting a polydispersity of the backbone segment between two side branches of at least 1.5, and preferably greater than 1.8.

In another, more preferential embodiment, the segments of each of the types of chemical or topological nature which make up the composition of the polymer according to the invention exhibit a polydispersity of at least 1.5, and preferably greater than 1.8.

According to a preferred embodiment, the polymers according to the invention have a molecular mass (weight average) of greater than 50 000, preferably greater than 300 000, more preferably greater than 1 000 000, and even more preferably greater than 3 000 000.

According to a preferred embodiment, the polydispersity of the polymers according to the invention is greater than 1.5, and preferably greater than 1.8.

The length and the number of the polymer segments present in the comb polymers or the copolymers used in the media according to the invention, and also their chemical nature, may significantly vary within the context of the invention, and it is thus possible to greatly vary the properties of said media depending on the desired application, as will be shown more specifically in the explanation of the examples of implementation.

The polymers contained in the solution according to the invention show significant affinity for the walls of said channel, in the presence of the fluid within which the transport or the separation is carried out.

A particularly preferred mode consists of a copolymer having at least one type of polymer segment showing, in the presence of the fluid, a particular affinity with the wall, and at least one type of polymer segment exhibiting, in said fluid, less or no affinity with the wall.

Typically, types of polymer segment which do not exhibit affinity with the wall consist of polymers which can be readily solubilized in the fluid. On the other hand, polymers may exist which are soluble in the fluid but nevertheless exhibit, in this fluid, a particular affinity for a wall. When the fluid is an aqueous solution, segments having no affinity with the wall are typically very hydrophilic segments. On the other hand, segments with affinity are relatively non-hydrophilic, or even hydrophobic. Of course, other, more specific types of affinity may be used, depending on the nature of the wall and that of the fluid. Copolymers which are optimized for use of the invention are in particular those in which all the segments exhibiting a particular affinity with the wall represent between 2 and 80% by mass, preferably between 5 and 50%, of the average total molar mass of said copolymers, or between 3 and 90%, and preferably between 5 and 60% of the total composition of the copolymers in number of moles of monomers.

According to another preferred embodiment, the copolymers which are optimized for use of the invention are in particular those in which all of the segments exhibiting a particular affinity with the wall represent between 2 and 25% by mass, preferably between 5 and 15%, of the average total molar mass of said copolymers, or between 3 and 30%, and preferably between 5 and 20% of the total composition of the copolymers in number of moles of monomers.

By way of illustration of the various structures which can be adopted by the polymer according to the invention, mention may most particularly be made of those in which all or part of said polymer is:

in the form of linear block copolymers. In this case, a preferred variant consists in alternating, along the polymer, segments exhibiting a particular affinity with the wall and segments exhibiting less or zero affinity for the wall;

in the form of comb polymers. In this case, according to a first preferred variant, all or part of said polymer is in the form of comb polymers with a backbone consisting of several polymer segments exhibiting a particular affinity with the wall, and with side branches consisting of polymer segments exhibiting less or zero affinity for the wall. According to a second preferred variant, all or part of said polymer is in the form of comb copolymers with side branches consisting of polymer segments exhibiting a particular affinity for the wall, and with a backbone consisting of polymer segments exhibiting less or zero affinity for the wall.

According to a preferred mode of the invention, all the polymer segments of a given type of chemical or topological nature have, along their backbone, more than 75 atoms, and even more preferably more than 210 atoms, or have a molecular mass of greater than 1 500, and preferably greater than 4 500.

According to an even more preferred mode, the various types of segment have, along their backbone, on average more than 16 atoms, preferably more than 75, and even more preferably more than 210, or have a molecular mass of greater than 1 500, and preferably greater than 4 500.

It is particularly advantageous for the implementation of the invention to use block copolymers or comb polymers in which one of the types of segment consists of a polymer chosen from polyethers, polyesters such as poly(glycolic acid), soluble random copolymers and homopolymers of the polyoxyalkylene type, such as polyoxypropylene, polyoxybutylene or polyoxyethylene, polysaccharides, polyvinyl alcohol, polyvinylpyrrolidone, polyurethanes, polyamides, polysulfonamides, polysulfoxides, polyoxazoline, polystyrenesulfonate, polyacrylamide and polymethacrylamide derivatives which may or may not be substituted, and polymers and copolymers bearing epoxy, amine, thiol or carboxylic acid functional groups.

By way of representation of the types of polymer segments exhibiting, in an aqueous fluid, little or no affinity with the walls, mention may most particularly be made of polyacrylamide and poly(acrylicacid), poly(N-isopropylacrylamide), polyacryloylaminopropanol, water-soluble acrylic and allylic polymers and copolymers, dextran, polyethylene glycol, polysaccharides and diverse derivatives of cellulose, such as hydroxyethylcellulose, methylcellulose, hydroxypropylcellulose, hydroxypropylmethylcellulose or methylcellulose, polyvinyl alcohol, polyurethanes, polyamides, polysulfonamides, polysulfoxides, polyoxazoline, polystyrenesulfonate, and also polymers bearing hydroxyl groups and all the random copolymers of the derivatives mentioned above.

Of course, other polymer segments soluble in the fluid may be used according to the invention, depending on the nature of said fluid and on that of the walls of the channel or container, on the particular application and on the ease with which they can be introduced into a block polymer of desired structure.

By way of representation of the types of polymer segment which may or may not be soluble in aqueous solvents and which may exhibit, in these solvents, a particular affinity with the walls, mention may be made of dimethylacrylamide, acrylamides N-substituted with alkyl functional groups, acrylamides N,N-disubstituted with alkyl functional groups, allyl glycidyl ether, copolymers of the above acrylic derivatives with one another or with other acrylic derivatives, alkanes, fluoro derivatives, silanes, fluorosilanes, polyvinyl alcohol, polymers and copolymers involving oxazoline derivatives, and also, in general, polymers exhibiting a combination of carbon-carbon bonds and/or of ether oxide functional groups and/or of epoxide functional groups, and also all the random copolymers of these compounds.

Many types of polymer segment may be chosen in order to constitute the polymer segments constituting a polymer according to the invention, depending on the electrolyte envisioned, from the types of polymer known to those skilled in the art, in particular from those which are, soluble in aqueous medium. It is thus possible to refer to the manual “Polymer Handbook” Brandrupt & Immergut, John Wiley, N.Y.

Another preferred embodiment, which is particularly advantageous when the species to be separated are biological macromolecules, consists in using copolymers according to the invention which also exhibit a different affinity with different analytes.

This affinity may be obtained by integrating into the structure of said polymers segments capable of exhibiting an affinity specific for certain species to be separated. Such segments may, in a nonexhaustive manner, consist, for example, of a predetermined sequence of different monomers, such as a polynucleotide or polypeptide. This affinity may also be obtained by associating with the polymer according to the invention a native or denatured protein, a protein fraction or a protein complex, or alternatively an acid or basic function and/or a function such as an acid or base in the Lewis sense.

According to this variant, it is possible to envision either alternating along a linear block copolymer segments exhibiting a specific affinity with certain analytes and segments exhibiting less or zero affinity with said analytes, or introducing into a comb copolymer polymer segments exhibiting an affinity specific for certain analytes, either in the form of additional side branches or of subsidiary segments in their backbone.

The polymers according to the invention may be natural or synthetic polymers. According to an additional mode which is particularly advantageous, due to the control which it allows over the structure, the polymers according to the invention are synthetic polymers.

The following are most particularly suitable for the invention:

copolymers of the linear block copolymer type, exhibiting along their backbone alternating segments of the polyoxyethylene type and segments of the polyoxypropylene type, or alternating segments of the polyoxyethylene type and segments of the polyoxybutylene type or, more generally, alternating segments of polyethylene and segments of polyether type, which are notably more hydrophobic than polyoxyethylene;

copolymers of the linear block copolymer type, exhibiting along their backbone alternating segments of the acrylamide, acrylic acid, acryloylaminoethanol or dimethacrylamide type, firstly, and segments of the (N,N)-dimethylacrylamide (pDMA) type or of the copolymer of DMA and of allyl glycidyl ether (AGE) type, or else of homopolymer or of copolymer of oxazoline or of oxazoline derivatives;

polymers of the comb polymer type, the backbone of which is of the type polymer of agarose, of acrylamide, of substituted acrylamide, of acrylic acid, of acryloylaminoethanol, of dimethylacrylamide (DMA), of allyl glycidyl ether (AGE), or random copolymer of DMA and of AGE, of oxazoline, of oxazoline derivatives, of dextran, of methylcellulose, of hydroxyethylcellulose, of modified celluloses, of polysaccharides, of ether oxides, and at the level of which are grafted side segments of the type polymer of agarose, of acrylamide, of substituted acrylamide, of acrylic acid, of acryloylaminoethanol, of dimethylacrylamide (DMA), of allyl glycidyl ether (AGE), or random copolymer of DMA and of AGE, of oxazoline, of oxazoline derivatives, of dextran, of methylcellulose, of hydroxyethylcellulose, of modified celluloses, of polysaccharides, of ether oxides, of N-isopropylacrylamide.

copolymers of the comb copolymer type, the backbone of which is of the type polymer of acrylamide, of substituted acrylamide, of acrylic acid, of acryloylaminoethanol, of dimethylacrylamide (DMA), of allyl glycidyl ether (AGE), or random copolymer of DMA and of AGE, of oxazoline, of oxazoline derivatives, of dextran, of agarose, of methylcellulose, of hydroxyethylcellulose, of modified celluloses, of polysaccharides, of ether oxides, and bears hydrophobic side segments containing short chains such as alkyl chains, aromatic derivatives, fluoroalkyls, silanes and fluorosilanes.

copolymers of the comb copolymer type, the backbone of which is of a type selected for its strong affinity for a wall of the channel or of the container of a particular chemical nature, and in particular of the type polyolefin, polymer of aromatic derivatives, of fluoroalkyls, of silanes, of fluorosilanes, and bears side segments of the type polymer of dextran, of agarose, of acrylamide, of substituted acrylamide, of acrylic acid, of acryloylaminoethanol, of dimethylacrylamide (DMA), of allyl glycidyl ether (AGE), or random copolymer of DMA and of AGE, of oxazoline, of oxazoline derivatives, of dextran, of methylcellulose, of hydroxyethylcellulose, of modified celluloses, of polysaccharides, of ether oxides, of N-isopropylacrylamide.

It should also be noted that, in the majority of applications, it is preferable to use an essentially neutral polymer according to the invention. It may, however, be useful for certain applications, and in particular to avoid adsorption of species exhibiting both charges and hydrophobic components, to choose a polymer according to the invention which is intentionally charged, preferably having a charge opposite to that of said species.

The copolymers according to the invention are advantageous because of their ability to combine properties belonging to polymers which are chemically different in nature, which cannot always be brought together in a homopolymer or a random copolymer. Thus, they allow more flexible adaptation of the chemical nature of the copolymer, as a function, firstly, of the chemical nature of the fluid and, secondly, of the chemical nature of the wall of the channels or containers. They are thus particularly advantageous in applications using channels or containers consisting of polymers or elastomers such as PDMS (polydimethylsiloxane), PMMA poly(methyl methacrylate), polycarbonate, polyethylene, polypropylene, polyethylene terephthalate, polyimide, polycyclohexane, polyurethanes or organic materials such as ordinary glass, borosilicate glass, Pyrex, molten silica, silicon oxide, ceramics, silicon, diamond, zirconium or semiconductors. Moreover, the polymers according to the invention have the unique property of being able to have, on each polymer, a considerable number of polymer segments exhibiting a significant affinity with the wall, which allows a large energy of absorption, and therefore a long-lasting reduction of electroosmosis, while at the same time also containing a considerable number of loops not exhibiting affinity with the walls, which may serve to avoid the adsorption of the species.

As regards the preparation of the polymers used according to the invention, it may be carried out by any conventional technique of polymerization or polycondensation. The choice of the method of preparation is generally made by taking into account the desired structure for the polymer, namely comb or linear, and the chemical nature of the various blocks constituting it.

By way of representation of these preparation variants, mention may most particularly be made of the processes according to which said polymers are obtained by:

ionic or radical polycondensation, polymerization or copolymerization of identical or different monomers, of identical or different macromonomers, or of a mixture of monomers and macromonomers, or

grafting of several polymer segments onto a linear or branched polymer backbone chemically identical or different in nature.

Preferably, all or some of the polymers used according to the invention are obtained by

a: copolymerization of monomers and macromonomers comprising at least one of their ends a reactive functional group, or

b: copolymerization of macromonomers comprising within their structure at least one reactive functional group.

For the purpose of the invention, the expression “reactive functional group” is intended to mean a group which allows the molecule bearing this group to be integrated into the macromolecule in the course of the copolymerization reaction without interrupting said copolymerization.

Depending on the applications, the chemical nature of the capillary for which the surface treatment solution is intended and the particular choice of polymer according to the invention used for the treatment, said solution may comprise, as a basis for dissolving the copolymers according to the invention, an aqueous (preferably buffered) solution, an organic solvent, an aqueous-organic solvent or an electrolyte.

In a preferred variant, the polymers contained in the surface treatment solutions according to the invention attach to the solid walls by physical adsorption without establishing a covalent bond.

According to another preferred variant, the polymers contained in the surface treatment solutions according to the invention attach to the solid walls via one or more covalent bonds.

Using the preferred rules and modes stated above, those skilled in the art are capable of preparing polymers in accordance with the invention, by adapting the structure, the nature and the method of preparation of said polymers as a function of the desired properties for one application or another.

A subject of the invention is also a process for treating the surface of an element, in particular to avoid the phenomena of electroosmosis and/or of nonspecific adsorption of species capable of manifesting themselves at this surface when it is brought into contact with a fluid, and/or of species contained in this fluid.

More precisely, it is a process for treating the surface of an element intended to be brought into contact with a fluid and/or species contained in this fluid during the transport, analysis, purification, separation and/or conservation of said fluid, comprising bringing said element into contact with at least one noncrosslinked polymer of the block copolymer or comb polymer typed having on average at least three junction points between polymer segments chemically or topologically different in nature.

For the definition of the polymer and of the element reference will be made to the preceding description.

According to a preferred variant of the invention, the polymer is used in the form of an aqueous solution of polymer as claimed and preferably containing said polymer at a concentration of between 0.01% and 20%, and more preferentially between 0.1 and 5% by mass.

According to a first embodiment, the process comprises treating the element, prior to its use, with a treatment solution in accordance with the invention.

When the treatment is carried out for the purpose of a transport or conservation operation, this solution has a composition different from that of the fluid intended to be transported or conserved. When the treatment is carried out for the purpose of a separation application, this solution has a composition different from that of the separation medium. The treatment is obtained by leaving said solution in contact with the walls for the necessary period of time. Depending on the application and the embodiment, this period of time may be very variable, ranging from a fraction of a second to several hours, or even, for the most difficult applications, several days. This solution is then removed from the channel or container, prior to or simultaneously with the filling thereof with said fluid. According to this variant, said fluid does not, itself, contain the polymers according to the invention. Thus, the latter remain present in the channel or the container only in a form adsorbed to the walls, and do not contribute to modifying the properties of said fluid. In particular, they do not significantly increase its viscosity. Depending on the application, this treatment may be renewed between each transport or separation operation, or, on the other hand, after a given number of separations or else when a degradation of the properties is noted, making it necessary.

According to a preferred variant of the invention, the bringing of said surface treatment solution into contact with the surface of the element with respect to which a reduction of the nonspecific adsorption or the electroosmosis is desired may be followed by a treatment intended to reinforce the action of said solution, such as, by way of nonlimiting example, thermal treatment, treatment by radiation (light radiation, ultraviolet radiation, X rays, gamma rays, etc.), drying of the wall, or incubation thereof in the presence of a liquid different from said solution.

However, this treatment is not always necessary, and some polymers according to the invention which are part of the composition of the surface treatment solutions of the invention are capable of effectively minimizing the nonspecific adsorption and the electroosmosis without subsequent treatment.

According to a preferred embodiment, in particular if many separations are carried out between two surface treatments with a solution according to the invention, the surface of the element may be “regenerated” before the treatment, with a solution intended to clean off the wall the impurities adsorbed in the course of the separations. Such treatments are known to those skilled in the art and may advantageously comprise washing with an acid solution, with an a alkaline solution, with a solution of detergent, with an organic solvent, or with a combination of these methods.

According to a second embodiment, the process claimed comprises the addition of said polymer to the fluid which must be transported, analyzed, purified, separated and/or conserved.

According to this second embodiment, the copolymers which characterize the surface treatment solutions according to the invention are preferably introduced directly into the fluid transported, conserved or used as a separation medium, at a concentration sufficiently low so as not to significantly modify, moreover, the other customary properties of said fluid, and in particular without increasing its viscosity more than 2-fold, relative to the same fluid in the absence of said polymers. According to an even more preferred variant, the polymers according to the invention do not modify the viscosity of said fluid more than 1.5-fold.

As regards the fluid into which the polymer according to the invention is directly introduced, it may advantageously contain, besides the polymers according to the invention, other elements, and in particular components which interact with the species either by steric interaction or by affinity, and which are capable of inducing between one another a total or partial separation of these species. Many components of this type, such as hydrophilic linear polymers, micelles, surfactants or chiral compounds are known to those skilled in the art.

Of course, the present invention extends to any process of separation, filtration, analysis and/or purification involving the use of the claimed process. These processes of filtration, separation, analysis and/or purification are partly identified below.

The present invention also relates to an element, preferably channel, container or particles, or any element intended to constitute a wall of a channel or of a container used in an operation of transport, analysis, purification, conservation or separation of a fluid or of species contained in this fluid, or intended to form part of said wall, treated with the surface treatment solution claimed.

Such elements may be used for the separation, purification, filtration or analysis of species chosen from molecular or macromolecular species, and in particular biological macromolecules such as nucleic acids (DNA, RNA, oligonucleotides), nucleic acid analogs obtained by chemical modification or synthesis, proteins, polypeptides, glycopeptides and polysaccharides, organic molecules, synthetic macromolecules or particles such as mineral particles, latex particles, cells or organelles.

The elements treated according to the invention are also of particular use for DNA sequencing insofar as they make it possible to obtain minimum bandwidths. Similarly, they are found to be suitable for separating proteins, proteoglycans or cells, for which it is known that problems of adsorption to the wall are particularly bothersome and particularly difficult to solve.

However, the possibility offered by the invention of greatly varying the chemical nature of the surface is also advantageous for other applications.

The surface treatment solutions according to the invention, the processes using these solutions and, more particularly, the elements treated according to the invention are of use for diagnostic, genotyping, high throughput screening and quality control applications, or for detecting the presence of genetically modified organisms in a product.

The invention is also particularly advantageous for “hybridization” or “affinity” techniques in which the intention is to analyze or separate, within a channel or a container, the species contained in a sample, as a function of their respective specific affinity for ligands. These ligands are either contained in said channel or container, or are attached at predetermined positions on the walls of said container or said channel. The invention makes it possible to carry out this type of analysis, while at the same time avoiding or minimizing the nonspecific adsorption of said species to the walls of the channel or of the container, or to solid surfaces contained in said channel or in said container.

According to a preferred embodiment, this type of ligand may be associated with the element, namely channel, container, element forming part of the composition of said channel or container, or particles, via a treatment with a surface treatment solution according to the invention. In this instance, the treatment solution according to the invention performs two functions. It reduces the nonspecific adsorption and provides said ligands or contributes to immobilizing them at the level of said element.

A family of polymers which is particularly advantageous for applications of analysis by affinity consists of a block copolymer simultaneously having

1/ a multiplicity of polymer segments exhibiting an affinity specific for a wall of the channel or of the container, or certain predetermined parts of said walls, or else with certain solid surfaces present in said channel or of said container, such as the surfaces of particles or latex beads, and

2/ one or more polymer segments not exhibiting affinity with said walls or surfaces, and bearing ligands specific to certain species, the analysis of which is desired. Said ligands may in particular be oligonucleotides, proteins, antibodies, peptides or, more generally, biological or synthetic polymers or polymer fragments.

The advantage of the invention in this application is that it keeps the ligands linked to said walls or surfaces indirectly, while at the same time maintaining said ligands at a considerable distance from the latter. Specifically, in the context of the invention, the polymer segment(s) bearing the ligands do not exhibit any affinity for the wall and are therefore pushed away from it by the steric interactions. The polymers according to the invention therefore enable the analytes to interact with the ligands, without approaching the walls.

A subject of the present invention is also the use of the claimed solution for minimizing the phenomena of adsorption or of electroosmosis which occur at the surface(s) of an element intended to be brought into contact with a fluid and/or species contained in this fluid during the transport, analysis, purification, separation or conservation of said fluid.

The invention is particularly advantageous for the transport, analysis or conservation of a biological fluid containing or liable to be contaminated with inorganic, organic or biological products or live organisms.

As regards the devices, the surface treatment solutions, the process and the components claimed are of particular use for microfluid systems, microtitration plates, “DNA chips and protein chips” and, more generally, all systems of transport and analysis involving high surface/volume ratios, since they make it possible, through the optimal choice of the various types of block within the polymers, to combine blocks exhibiting good affinity for the surface of the walls in order to obtain a long-lasting treatment, and blocks exhibiting good repulsion for the species to be separated, whatever said species may be and whatever the chemical nature of said component.

The figures and examples given below are presented by way of nonlimiting illustration of the present invention.

### FIGURES

FIG. 1: Control electropherogram representing the separation of the 50-500 bp sizer, Pharmacia biotech, obtained at 50° C. in an ABI 310 device (Perkin-Elmer), using as separation medium a 100 mM Na TAPS buffer containing 2 mM EDTA and 7 M urea, in which 5% by weight of linear acrylamide (molecular mass 700 000-1 000 000) is dissolved, in a nontreated capillary. The numbers above the peaks indicate the size of the corresponding DNA fragment.

FIG. 2: Control electropherogram representing a separation identical to that of FIG. 1, in a capillary pretreated for 2 hours with an aqueous solution containing 3% of triblock copolymer “pluronic F127” (BASF). The numbers above the peaks indicate the size of the corresponding DNA fragment.

FIG. 3: Electropherogram representing a separation identical to that of FIG. 1, in a capillary pretreated for 2 hours min with an aqueous solution containing 3% of comb polymer of the type having a hydroxyethylcellulose backbone, carrying side chains of the short alkyl chain type (NATROSOL PLUS 331, Aqualon). The numbers above the peaks indicate the size of the corresponding DNA fragment.

FIG. 4: Electropherogram representing a separation identical to that of FIG. 1, in a capillary pretreated for 2 hours min with an aqueous solution containing 3% of the copolymer according to the invention “PDMA-NIPAM” described in example 2. The numbers above the peaks indicate the size of the corresponding DNA fragment.

FIG. 5: Electropherogram representing a separation identical to that of FIG. 1, in a nontreated capillary, with copolymer according to the invention “PDMA-NIPAM” described in example 2 being added to the separation medium at a concentration by mass of 0.5%. The numbers above the peaks indicate the size of the corresponding DNA fragment.

FIG. 6: Electropherogram representing a separation identical to that of FIG. 2,

6a/ with polymer “PAM-PDMA-1” described in example 4 being added to the separation medium at a concentration by mass of 0.5%; the numbers above the peaks indicate the size of the corresponding DNA fragment.

6b/ after treatment of the capillary for 2 hours with an aqueous solution containing 3% of the polymer PAM-PDMA described in example 4. The numbers above the peaks indicate the size of the corresponding DNA fragment.

FIG.7: Comparison of the calculated resolution between peaks differing by one base to 500 bases, obtained at 50° C. in an ABI 310 device (Perkin-Elmer), using as separation medium a 100 mM Na TAPS buffer containing 2 mM EDTA and 7 M urea, in which 5% of linear acrylamide (molecular mass 700 000-1 000 000) is dissolved, in a capillary initially not treated (“no treatment”), and after pretreatment of the capillary with an aqueous solution containing 3% of the various polymers F127, Natrosol Plus, “PDMA-NIPAM” described in example 2 and PAM-PDMA-1 described in example 4.

FIG. 8: Comparison of the resolution according to the number of base pairs for the separation of a “50-500 bp sizer” (Pharmacia-Amersham), in a solution containing 5% of linear polyacrylamide exhibiting no wall treatment properties, in a 2 mM EDTA, 0.1 M Taps, 7 M urea buffer with addition of 0.5% of the following polymers according to the invention:

poly(AM-PDMA)-1 (prepared according to example 4),

poly(AM-PDMA)-2 (prepared according to example 8),

poly(AM-PDMA)-3 (prepared according to example 9),

poly(DMA-PNIPAM) (prepared according to example 2),

and, by way of comparison, with addition of 0.5% of linear PDMA homopolymer.

### EXAMPLE 1

Preparation of a functionalized PNIPAM macromonomer of average molecular mass in the region of 10 000 for the purpose of preparing copolymers in accordance with the invention.

1) Polymerization of the NIPAM

The radical polymerization of the NIPAM is carried out in pure water. The initiator is a redox couple in which the oxidant is potassium persulfate, K₂S₂O₈ (KPS), and the reducing agent is aminoethanethiol (AET), HCl. The initiating reaction is:

K₂S₂O₈+2Cl⁻, NH₃⁺—CH₂CH₂—SH→2KHSO₄+2Cl⁻, HN₃⁺—CH₂—CH₂—S.

The AET, HCl also plays the role of a transfer agent, which makes it possible to control the length of the chains.

Procedure

20 g of NIPAM (0.18 mol) and 200 ml of water are introduced into a 500 ml three-necked flask surmounted by a cooling apparatus and equipped with a nitrogen inlet device. The mixture is then stirred and heated to 29° C. with a water bath. The sparging of nitrogen is begun. After 45 minutes, 0.602 g of AET, HCl (0.0054 mol) dissolved beforehand in 20 ml of water are added, followed by 0.478 g of potassium persulfate (KPS) dissolved in a minimum amount of water. The mixture is maintained with stirring for 3 hours. Next, the solution is concentrated and then lyophilized.

To isolate the polymer a precipitation is performed according to the following procedure:

The solid obtained is redissolved in 100 ml of methanol. The hydrochloride present is neutralized by adding 0.0054 mol of KOH (i.e. 0.302 g dissolved in approximately 25 ml of methanol) incorporated dropwise in the solution. The salt formed, KCl, precipitates and is extracted by filtration. The filtrate thus recovered is concentrated and then poured dropwise into 4 liters of ether. The polymer precipitates and is recovered by filtration over sintered glass No. 4. The solid is then dried under vacuum by a vane pump. The mass yield is of the order of 50%.

The above protocol produces an aminated polymer name “PNIPAM-A-C”, and corresponds to initiator-monomer ratios Ro=0.03 and Ao=0.01, where:

Ro=[R—SH]/[NIPAM] and Ao=[KPS]/[NIPAM].

2) Modification of the aminated PNIPAM, PNIPAM-A-C

The PNIPAM macromolecules synthesized have amine functional groups at the end of the chains, these functional groups originating from the initiator aminoethanethiol, AET, HCl.

By reacting the amine functional group on acrylic acid, a vinyl double bond is attached to the end of the chain according to the following reaction scheme:

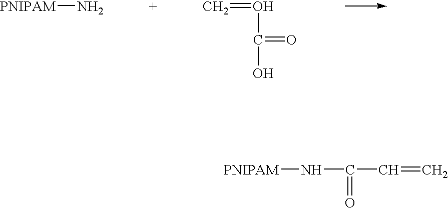

Procedure:

50 ml of methylene chloride, 1.5 g of acrylic acid (0.021 mol), 9 g of PNIPAM and 4.3 g of dicyclohexylcarbodiimide (DCCI) (0.021 mol) are introduced into a 100 ml beaker.

The reaction medium is stirred for one hour. Since the acrylic acid is in great excess relative to the PNIPAM (the amount of acrylic acid is approximately twenty times that of the PNIPAM), all of the amino functional groups were modified. The mixture is then filtered over sintered glass No. 4 in order to remove the dicyclohexylurea precipitate, a byproduct resulting from the transformation of the DCCI.

The mixture is then concentrated down to 15 ml and then transferred dropwise into 200 ml of ether in order to precipitate the polymer. The mixture is filtered over sintered glass No. 4 and the solid is washed with three times 100 ml of ether and then dried under vacuum by the vane pump overnight.

A macromonomer PNIPAM-C bearing an allyl functional group at the end of the chain is thus obtained, with a mass yield of the order of 70%.

The molar masses of the macromonomers thus prepared were measured by SEC (steric exclusion chromatography) in THF at 40° C., with an ultrastyragel column, refractometric double detection and universal calibration with respect to polystyrene samples. NB: I have simplified here.

Other macromonomers (NIPAM) were prepared according to this protocol. They are listed in table I below and are characterized in terms of polydispersity and molecular weight for each of the two types of segment and by weight.

These results show that it is possible to vary the average molecular mass of the macromonomers by varying the temperature of polymerization and the initiator/polymer ratio Ro, the highest Ro ratios leading to the lowest molecular masses. They also show that the polydispersities of the macromonomers are high, in general greater than 2.

TABLE 1

| Molecular mass | PNIPAM-C | PNIPAM-5 | PNIPAM-M | PNIPAM-10 | PNIPAM-L | PNIPAM-20 |
|---|---|---|---|---|---|---|
| Preparation | Ro = 0.03 | Ro =0.025 | Ro = 0.02 | Ro = 0.02 | Ro = 0.015 | Ro = 0.01 |
| conditions | 23° C. | 23° C. | 25° C. | 29° C. | 25° C. | 25° C. |
| Mw (g/mol) | 10 800 | 12 800 | 15 800 | 20 400 | 23 000 | 34 000 |
| Average number | 200 | 230 | 290 | 370 | 420 | 620 |
| of atoms along | | | | | | |
| the chain | | | | | | |
| Polydispersity | 5.7 | 2.0 | 4.2 | 3.2 | 4.9 | 5 |
| (Mw/Mn) | | | | | | |

### EXAMPLE 2

Preparation of a PDMA-NIPAM copolymer with a comb structure and comprising the PNIPAM-C prepared in example 1, as segments devoid of significant affinity with the wall, and poly(N,N-dimethylacrylamide) (PDMA) as backbone showing an affinity with the wall.

The copolymerization of the PNIPAM-C (0.7 g) and of the DMA (2.8 g) is carried out for 4 h in 30 ml of water at ambient temperature, with vigorous degassing with argon. The initiator used is the redox couple ammonium persulfate ((NH₄)₂SO₂O₈) (0.1 mol % of the amount of monomers)—sodium metabisulfite (Na₂S₂O₅) (0.03 mol % of the amount of monomers). The resulting copolymer is purified by ultrafiltration in a “Minitan millipore®”, equipped with a membrane having a cutoff of 30 000, and then lyophilized. The final level of incorporation of PNIPAM 10, measured by proton NMR on the polymers diluted to 2 g/100 ml in heavy water (Bruker devices at 250 MHz) is 6.5%. The molecular mass, measured in water at 25° C. by steric exclusion chromatography on a “Shodex®” column with refractometric double detection and two angle light scattering (Precision Detector), is Mw=3 000 000, and the polydispersity is 2. The average number of side branches along the backbone is deduced from these values and from the molecular mass of the PNIPAM-C, and is of the order of 18.

Due to the method of radical polymerization used, the macromonomers constituting the side chains are integrated into the polymer chain at random positions determined by the chance of collisions between molecules (statistical distribution). This method of polymerization leads to the form of the distribution of the molecular masses of the polymer segments of the backbone between two side branches being approximately exponential, and therefore to the polydispersities of said polymer segments of the backbone being largely greater than 1.8.

### EXAMPLE 3

Preparation of a macromonomer of the PDMA type bearing an acrylic functional group at one end: the reaction is carried out according to the same protocol as example. 1, replacing one mole of NIPAM with one mole of DMA. The purification is carried out by precipitation from ether and then filtration.

### EXAMPLE 4

Preparation of copolymer “PAM-PDMA-1”, having an acrylamide backbone which does not interact with the wall and pDMA grafts exhibiting strong affinity with silica walls.

The copolymerization of the pDMA macromonomers prepared in example 3 (0.7 g) and of acrylamide (2.8 g) is carried out for 4 h in 30 ml of water at ambient temperature, with vigorous degassing with argon. The initiator used is the redox couple ammonium persulfate ((NH₄)₂S₂O₈) (0.1% of the amount of monomers)—sodium metabisulfite (Na₂S₂O₅) (0.03 mol % of the amount of monomers). The resulting copolymer is purified by ultrafiltration in a “Minitan millipore®”, equipped with a membrane having a cutoff of 30 000, and then lyophilized. The molecular mass, measured by exclusion chromatography (conditions identical to example 2), is Mw=813 kDa, and the polydispersity is 2.2. The mass proportion of pDMA, measured by NMR, is 6.5%, which corresponds on average to 5 side branches along the backbone. As in example 2, the method of radical polymerization used leads to a high polydispersity of the polymer segments of the backbone between two side branches.

### EXAMPLE 5

Separation properties obtained for DNA (50-500 bp sizer, Pharmacia biotech), with and without treatment of the silica capillary with the copolymers prepared according to example 2:

The electropherograms are obtained at 50° C. in an ABI 310® device (Perkin-Elmer), in a 50 mM Na TAPS buffer containing 2 mM EDTA and 7 m urea,

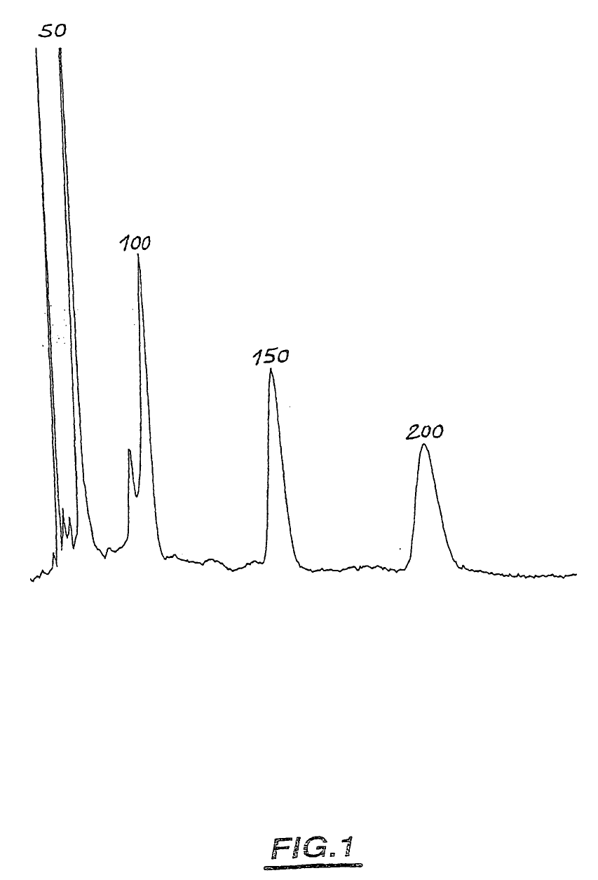

a) in acrylamide without pretreatment of the capillary (FIG. 1)

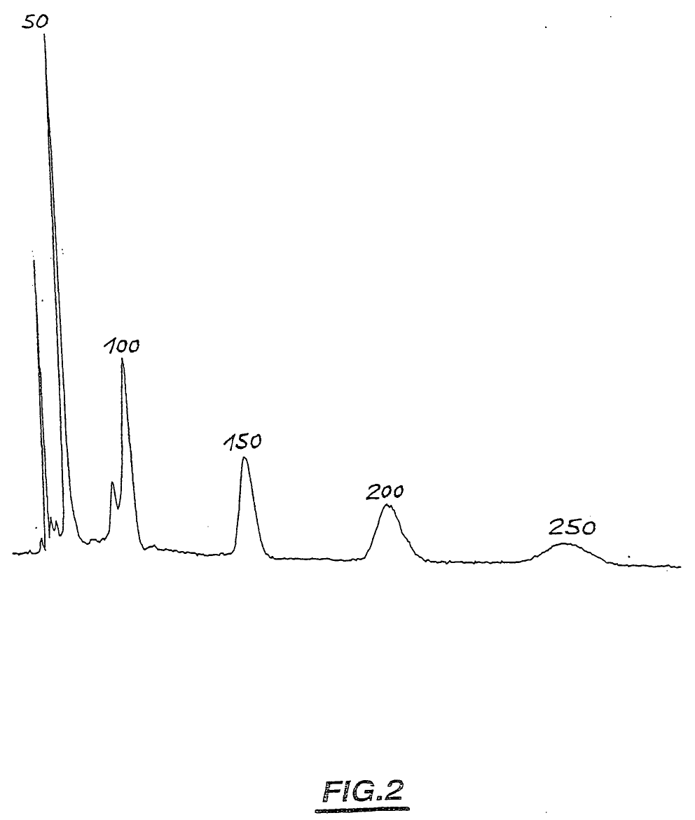

b) in acrylamide after treatment of the capillary with a commercial triblock copolymer “pluronics F127”, BASF (FIG. 2)

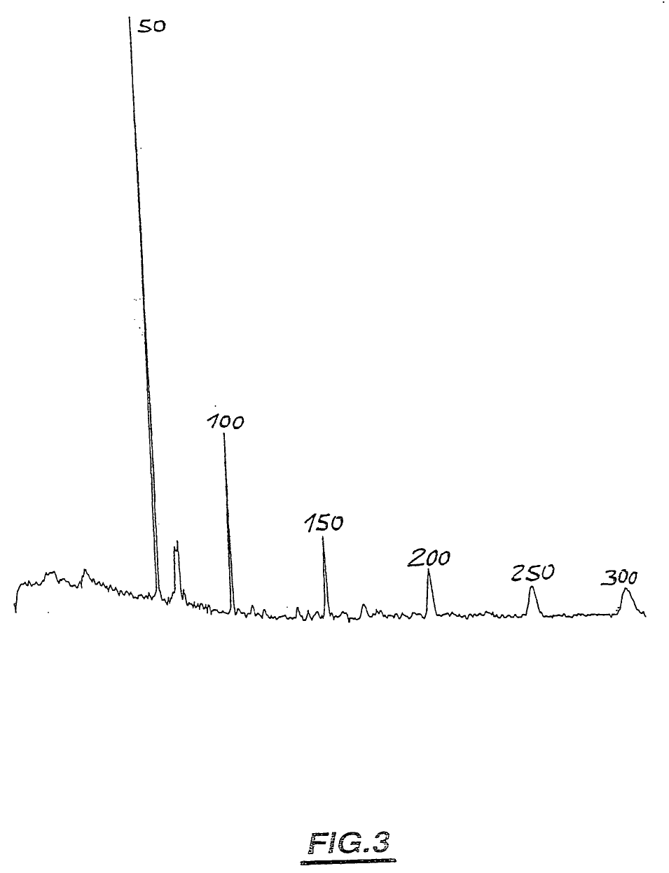

c) in acrylamide after treatment of the capillary with a commercial comb copolymer having a hydroxyethylcellulose backbone bearing short-chain alkyl functional groups (Natrosol Plus 331, Aqualon) (FIG. 3)

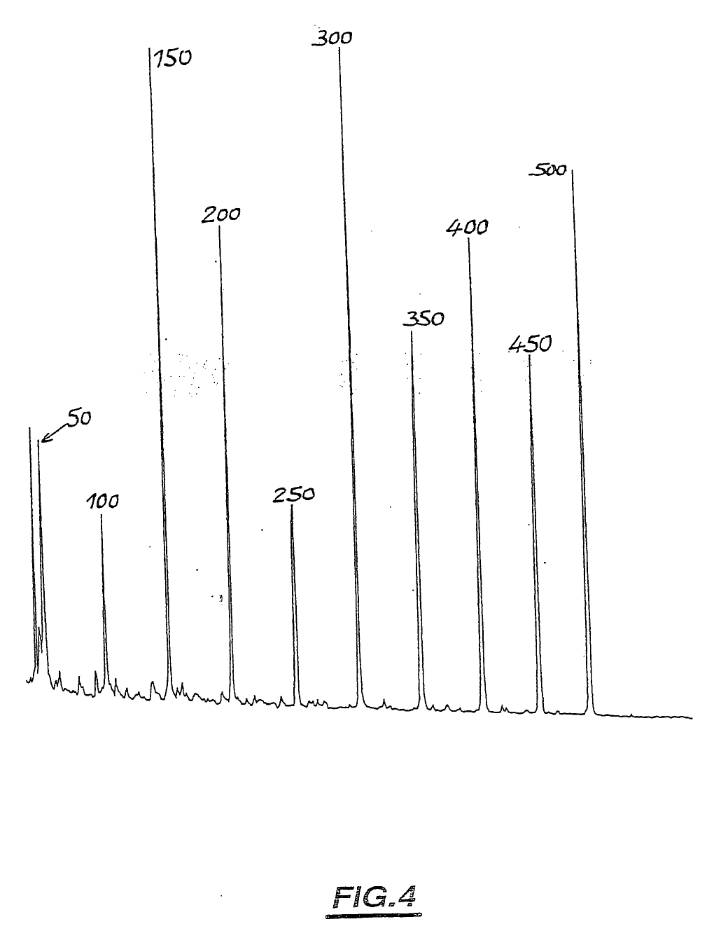

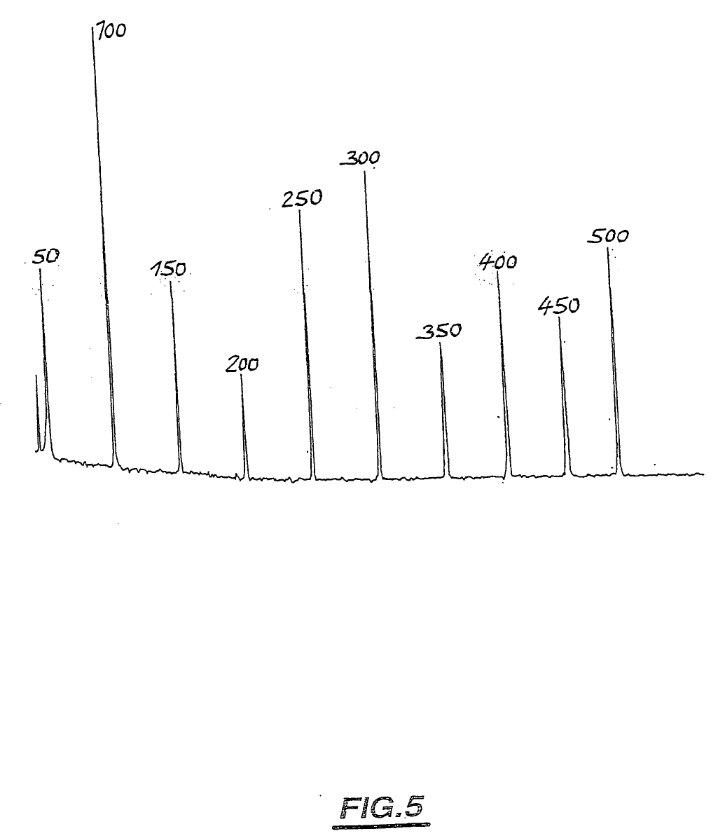

d) in acrylamide after treatment with the copolymer PDMA-NIPAM prepared according to example 2 (FIG. 4)

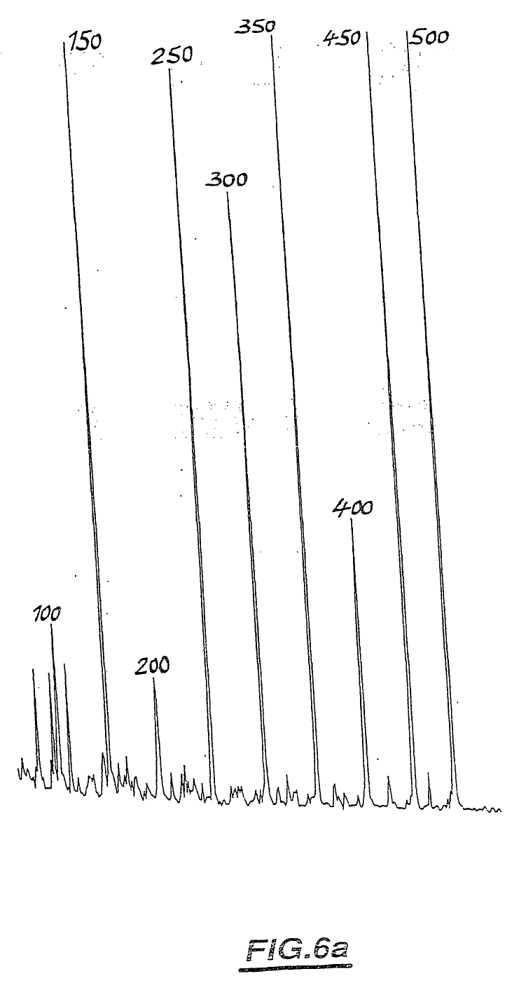

e) in acrylamide with addition of 0.5% of the copolymer. PDMA-NIPAM prepared according to example 2, to e separation medium (FIG. 5).

It is noted that the use of copolymers according to the invention considerably improves the sharpness of the peaks, whether this is in the form of treatment of the capillary before separation (FIG. 3 and 4), or in the form of addition to the separation medium itself (FIG. 5). This augmentation, which is very marked with respect to the nontreated capillary (FIG. 1), is also significant with respect to a capillary treated with a commercial block copolymer which does not have the minimum number of polymer segments which characterize the invention (FIG. 2). Finally, it is also noted that the copolymers exhibiting side branches of high molecular mass and irregular length (FIG. 4 and 5) lead to better separations than those exhibiting branches which are of low molecular mass and monodisperse (FIG. 3).

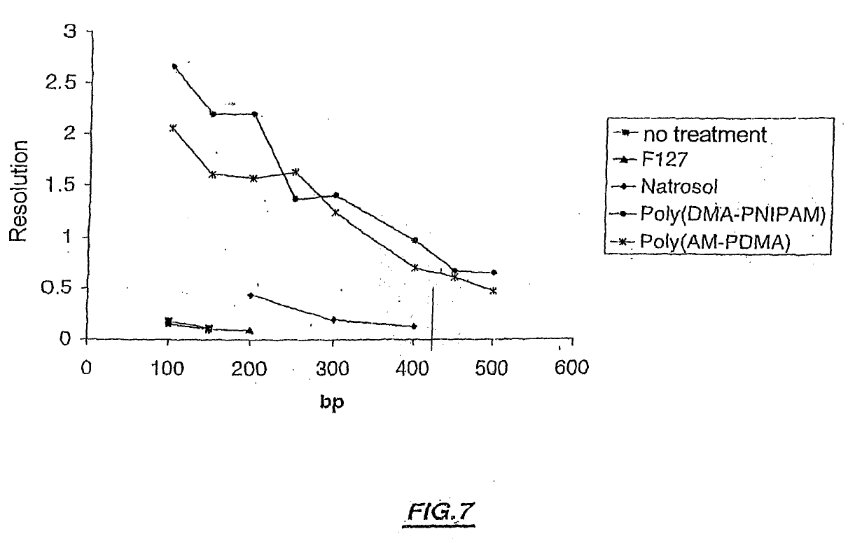

FIG. 7 represents the extrapolated resolution between peaks differing by one base, evaluated by interpolation from the results of the “Sizer 500”. It is once again noted that this resolution is improved by the polymers according to the invention.

### EXAMPLE 6

Separation properties obtained for DNA (50-500 bp sizer, Pharmacia biotech), at 50° C. in an ABI 310 device (Perkin-Elmer), in a 50 mM Na TAPS buffer containing 2 mM EDTA and 7 M urea.

These properties are evaluated according to two variants:

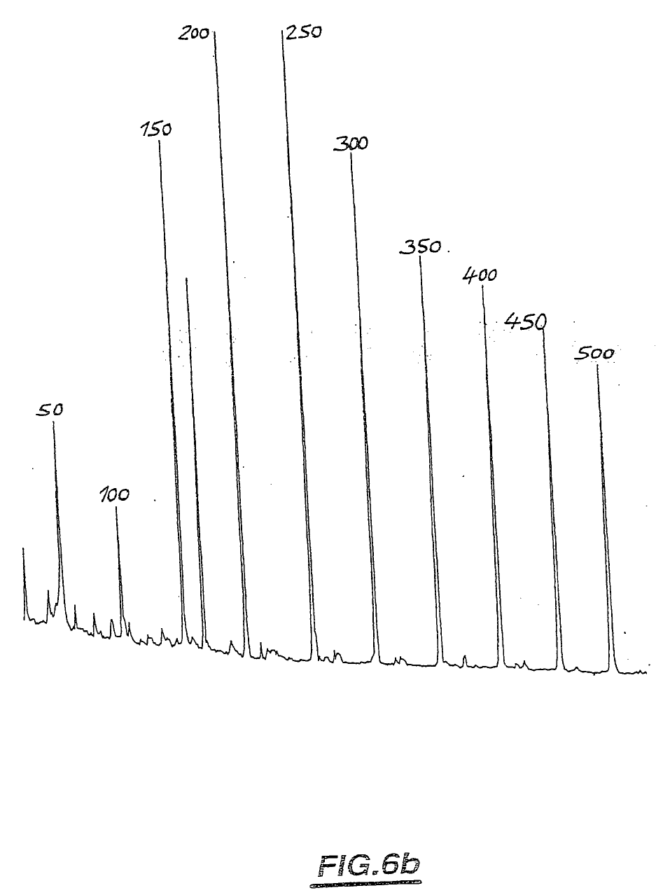

a) in acrylamide with addition of 0.5% of the copolymer PAM-PDMA-1 prepared according to example 4, to the separation medium (FIG. 6a);

b) in acrylamide after treatment with the copolymer PAM-PDMA-1 prepared according to example 4 (FIG. 6b).

Compared with FIG. 1, it is once again noted that the use of this other copolymer according to the invention considerably improves the sharpness of the peaks, whether this is in the form of treatment of the capillary before separation or in the form of addition to the separation medium itself. This increase in performance is found in the measurement of the resolution, FIG. 7.

This sharpness of peaks is attributed to the property of the processes according to the invention, which makes it possible to reduce interaction of the analytes with the wall. The better performances obtained with the copolymers exhibiting polymer segments of high and irregular molecular mass are attributed to the formation of a thick and “flexible” adsorbed layer. Such a layer would make it possible to push the analytes away from the wall, while at the same time remaining very swollen with water and therefore relatively unlikely to give specific interactions with these analytes.

### EXAMPLE 7

Use of a surface treatment solution according to the invention in a microfluid cell.

A microfluid cell comprising a channel 20 μm thick and 100 μm wide is prepared with polydimethylsiloxane, as described in Ocvirk et al., Electrophoresis, 21, 107 (2000). The walls of the channel are treated by incubation for 30 min, a/ with a solution containing 3% of “Pluronics F127” and b/ with a solution containing 3% of polymers according to the invention PDMA-NIPAM, prepared according to example 2. In both cases, the channel is rinsed, then filled with a solution of magnetic particles and subjected to a magnetic field of 60 mTestla, as described in Mayer et al., Mat. Res. Soc. Symp. Proc. 463, 57 (1998). The presence of electroosmosis is tested by the movement of the magnetic particles, in an electric field of 20 V/cm. For the capillary treated with the Pluronics, this displacement appears after the field has been applied for 2 to 3 min. For the capillary treated with the polymer according to the invention, there is still no observable displacement after the field has been applied for 3 hours. The copolymer additives according to the invention thus provide the means for better control of the transport of a fluid or of species contained in this fluid, in microfluid channels which are varied in nature.

### EXAMPLE 8

Preparation of a copolymer P(AM-PDMA)-2 having an acrylamide backbone and PDMA grafts, of molecular mass approximately 3 000 kdalton.

The preparation is identical to that described in example 4, except for the concentration of ((NH₄)₂S₂O₈) [0.1 mol % instead of 0.075 mol % of the amount of monomers] and of (Na₂S₂O₅) (0.015 mol % instead of 0.0225 mol % of the amount of monomers). The viscosity, given in FIG. 6, makes it possible to evaluate the molecular mass, which is of the order of 3 000 kDalton, from that of the p(AM-PDMA)-1, using the cubic dependency of the viscosity as a function of the molecular mass for entangled polymers.

### EXAMPLE 9

Preparation of a copolymer P(AM-PDMA)-3 bearing PDMA grafts, of molecular mass approximately 30 000

First, the macromonomer of molecular mass 30 000 is prepared as described in example 3, except for the Ro ratio, which is set at 0.015 instead of 0.03. This macromonomer is then polymerized with acrylamide, according to the protocol described in example 9.

### EXAMPLE 10

Evaluation of the performances of separation media incorporating a copolymer in accordance with the invention The polymers added in a proportion of 0.5% are:

poly(AM-PDMA)-1 prepared according to example 4,

poly(AM-PDMA)-2 prepared according to example 8,

poly(AM-PDMA)-3 prepared according to example 9,

poly(DMA-PNIPAM) prepared according to example 2, and

the linear PDMA homopolymer which represents the comparative test.

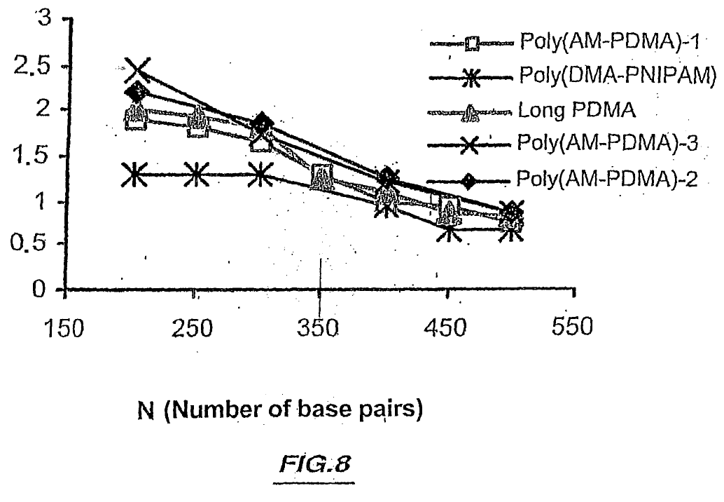

The results obtained are given in FIG. 8.

It is noted that the copolymers according to the invention produce performances comparable to or greater than those of the PDMA homopolymer, despite a much smaller fraction of monomers exhibiting a strong affinity for the wall. It is also noted that the polymers of higher molecular mass (poly(AM-PDMA)-2), and also those in which the grafts are of higher molecular mass (poly(AM-PDMA-3), produce the best resolution. On the other hand, the most hydrophobic polymer (poly(PDMA-NIPAM) produces the poorest resolution. In the particular case of poly(AM-PDMA)-2, 10 consecutive tests were carried out without intermediate regeneration of the walls of the channel.

Advantageously, no decrease in performances is observed.

It is important to note that the linear PDMDL homopolymer does not make it possible to obtain such results.

1. A subject of the present invention is a solution for treating the surface of an element intended to be brought into contact with a fluid and/or species contained in this fluid during the transport, analysis, purification, separation or conservation of said fluid, characterized in that said solution comprises at least one polymer composed of several polymer segments, said polymer being of the block copolymer or comb polymer type and having on average at least three junction points between polymer segments chemically or topologically different in nature.

2. The surface treatment solution as claimed in claim 1, characterized in that all the segments of at least one type of chemical or topological nature which go to make up the composition of said polymer exhibit a polydispersity of at least 1.5.

3. The surface treatment solution as claimed in claim 2, characterized in that the segments of each of the types of chemical or topological nature which make up the composition of the polymer exhibit a polydispersity of at least 1.5.

4. The surface treatment solution as claimed in claim 2 or 3, characterized in that the polydispersity is greater than 1.8.

5. The surface treatment solution as claimed in one of the preceding claims, characterized in that said polymer has an average molecular mass greater than 50 000, and preferably greater than 300 000.

6. The surface treatment solution as claimed in one of the preceding claims, characterized in that all the polymer segments of at least one type of chemical or topological nature have on average more than 75 atoms, and preferably more than 210, or have a molecular mass greater than 1 500, and preferably greater than 4 500.

7. The surface treatment solution as claimed in claim 6, characterized in that the various types of polymer segment making up said polymer have on average more than 75 atoms, and more preferably more than 210, or have a molecular mass greater than 1 500, and preferably greater than 4 500.

8. The surface treatment solution as claimed in one of the preceding claims, characterized in that said polymer has at least one type of polymer segment showing, within the separation medium, a specific affinity with the wall, and at least one type of polymer segment exhibiting, in said medium, less or no affinity with the wall.

9. The surface treatment solution as claimed in one of the preceding claims, characterized in that all the segments exhibiting a specific affinity with the wall represent between 2 and 80% by mass of the average total molar mass of said polymer.

10. The surface treatment solution as claimed in claim 9, characterized in that all the segments exhibiting a specific affinity with the wall represent between 2 and 25% by mass of the average total molar mass of said polymer.

11. The surface treatment solution as claimed in one of the preceding claims, characterized in that the polymer has on average a number of junction points of between 4 and 100, and preferably of between 4 and 40.

12. The surface treatment solution as claimed in one of the preceding claims, characterized in that the polymer is a block copolymer having on average at least four polymer segments.

13. The surface treatment solution as claimed in one of claims 1 to 11, characterized in that the polymer is a comb polymer having on average at least two side chains.

14. The surface treatment solution as claimed in claim 13, characterized in that the polymer is a comb copolymer with a backbone consisting of several polymer segments exhibiting a particular affinity with the wall, and with side branches consisting of polymer segments exhibiting less or zero affinity for the wall.

15. The surface treatment solution as claimed in claim 13, characterized in that the polymer is a comb copolymer with side branches consisting of polymer segments exhibiting a particular affinity for the wall, and with a backbone consisting of polymer segments exhibiting less or zero affinity for the wall.

16. The surface treatment solution as claimed in one of the preceding claims, characterized in that the polymer comprises at least one type of segment chosen from polyethers, polyesters such as poly(glycolic acid), soluble random copolymers and homopolymers of the polyoxyalkylene type, such as polyoxypropylene, polyoxybutylene or polygxyethylene, polysaccharides, polyvinyl alcohol, polyvinylpyrrolidone, polyurethanes, polyamides, polysulfonamides, polysulfoxides, polyoxazoline, polystyrenesulfonate, polymers and copolymers of acrylamides of methacrylamides and of allyls, which may or may not be substituted, and polymers and copolymers bearing epoxy, amine, thiol or carboxylic acid functional groups.

17. The surface treatment solution as claimed in one of the preceding claims, characterized in that said polymer is chosen from:
copolymers of the comb copolymer type, the backbone of which is of the dextran, acrylamide, acrylic acid, acryloylaminoethanol or (N,N)-dimethylacrylamide type and at the level of which are grafted side segments of the acrylamide, substituted acrylamide, (N,N)-dimethylacrylamide (DMA), N-isopropylacrylamide type or of the copolymer of DMA and of allyl glycidyl ether (AGE) type, or homopolymer or copolymer of oxazoline or of oxazoline derivatives;
copolymers of the linear block copolymer type, exhibiting along their backbone alternating segments of the polyoxyethylene type and segments of the polyoxypropylene type, or alternating segments of the polyoxyethylene type and segments of the polyoxybutylene type or alternating segments of polyethylene and segments of the polyether type, which are more hydrophobic than polyoxyethylene;
copolymers of the linear block copolymer type, exhibiting along their backbone alternating segments of the acrylamide, acrylic acid, acryloylaminoethanol or dimethylacrylamide type, firstly, and segments of the (N,N)-dimethylacrylamide (DMA) type or of the copolymer of DMA and of allyl glycidyl ether (AGE) type, or else of homopolymer or of copolymer of oxazoline or of oxazoline derivatives;
polymers of the comb polymer type, the backbone of which is of the type polymer of agarose, of acrylamide, of substituted acrylamide, of acrylic acid, of acryloylaminoethanol, of dimethylacrylamide (DMA), of allyl glycidyl ether (AGE), or random copolymer of DMA and of AGE, of oxazoline, of oxazoline derivatives, of dextran, of methylcellulose, of hydroxyethylcellulose, of modified celuloses, of polysaccharides, of ether oxides, and at the level of which are grafted side segments of the type polymer of agarose, of acrylamide, of substituted acrylamide, of acrylic acid, of acryloylaminoethanol, of dimethylacrylamide (DMA), of N-isopropylacrylamide, of allyl glycidyl ether (AGE), or random copolymer of DMA and of AGE, of oxazoline, of oxazoline derivatives, of dextran, of methylcellulose, of hydroxyethylcellulose, of modified celluloses, of polysaccharides, of ether oxides
copolymers of the comb copolymer type, the backbone of which is of the type polymer of acrylamide, of substituted acrylamide, of acrylic acid, of acryloylaminoethanol, of dimethylacrylamide (DMA), of allyl glycidyl ether (AGE), or random copolymer of DMA and of AGE, of oxazoline, of oxazoline derivatives, of dextran, of agarose, of methylcellulose, of hydroxyethylcellulose, of modified celluloses, of polysaccharides, of ether oxides, and bears hydrophobic side segments containing short chains such as alkyl chains, aromatic derivatives, fluoroalkyls, silanes and fluorosilanes.

18. The treatment solution as claimed in one of the preceding claims, characterized in that the polymer also comprises segments exhibiting an affinity for species to be separated within a fluid.

19. The surface treatment solution as claimed in one of the preceding claims, characterized in that said polymer attaches to the solid surfaces via one or more covalent bonds.

20. The surface treatment solution as claimed in one of the preceding claims, characterized in that said polymer attaches to the solid surfaces only via physical adsorption.

21. The solution as claimed in one of the preceding claims, characterized in that said polymer is present in said solution at a concentration of between 0.01% and 20% by weight.

22. A process for treating the surface of an element intended to be brought into contact with a fluid and/or species contained in this fluid during the transport, analysis, purification, separation and/or conservation of said fluid, comprising bringing said element into contact with at least one noncrosslinked polymer of the block copolymer or comb polymer type, having on average at least three junction points between polymer segments chemically or topologically different in nature.

23. The process as claimed in claim 22, characterized in that the polymer is used in the form of a solution.

24. The process as claimed in claim 23, characterized in that the polymer is used in the form of an aqueous solution containing said polymer according to the invention at a concentration of between 0.01% and 20%, and preferably between 0.1 and 5% by mass.

25. The process as claimed in one of claims 22 to 24, characterized in that the polymer is as defined in claims 2 to 21.

26. The process as claimed in claim 23 or 25, characterized in that the bringing of said element into contact with said solution is carried out prior to its use for the transport, analysis, purification, separation or conservation of said fluid.

27. The process as claimed in claim 22 or 25, characterized in that it comprises the introduction of said polymer into the fluid which must be transported, analyzed, purified, separated or conserved.

28. The process as claimed in one of claims 22 to 27, characterized in that the element treated is a channel, a container, one or more particles or an element intended to be part of the wall of a channel or of a container.

29. A process of separation, filtration, analysis and/or purification involving the use of the process as claimed in one of claims 22 to 28.

30. An element treated using a process as claimed in one of claims 22 to 28.

31. The use of an element as claimed in claim 30, for the separation, purification, filtration or analysis of species chosen from molecular or macromolecular species, biological macromolecules such as nucleic acids (DNA, RNA, oligonucleotides), nucleic acid analogs obtained by chemical modification or synthesis, proteins, polypeptides, glycopeptides and polysaccharides, organic molecules, synthetic macromolecules or particles such as mineral particles, latex particles, cells or organelles.

32. The use of an element as claimed in claim 30, for DNA sequencing or for protein separation.

33. The use of an element as claimed in claim 30, for the analysis or separation of species by affinity or molecular hybridization.

34. The use of an element as claimed in claim 30, in a microfluid system.

35. The use of an element as claimed in claim 30, for diagnostic, genotyping, high throughput screening or quality control applications, or for detecting the presence of genetically modified organisms in a product.

36. The use of a solution as claimed in one of claims 1 to 21, for minimizing the phenomena of adsorption or of electroosmosis which occur at the surface(s) of an element intended to be brought into contact with a fluid and/or species contained in this fluid during the transport, analysis, purification, separation or conservation of said fluid.

37. The use as claimed in claim 36, characterized in that the fluid is a biological fluid, a fluid containing or liable to be contaminated with organic or biological products, or a fluid containing or liable to be contaminated with live organisms.

38. The use as claimed in claim 36 or 37, characterized in that the element is a channel, a container, one or more particles, or an element intended to be part of the wall of a channel or of a container.
